(19) United States
(12) Patent Application Publication
(10) Pub. No.: US 2005/0058771 A1
(43) Pub. Date: Mar. 17, 2005

(54) ROLLING CONTACT SCREENING METHOD AND APPARATUS

(75) Inventors: L. Wynn Herron, New Paltz, NY (US); James N. Humenik, LaGrangeville, NY (US); David C. Long, Wappingers Falls, NY (US); Jason S. Miller, Poughkeepsie, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 10/605,219

(22) Filed: Sep. 16, 2003

(51) Int. Cl. B05D 5/12

(52) U.S. Cl. 427/96.1; 427/98.4; 118/213

(57) ABSTRACT

A method of applying paste to an electronic circuit board substrate containing via openings comprises providing over the substrate a mask having openings therein for lines and openings corresponding to the substrate via openings, and providing a roller having a surface adjacent the roller. Paste is then applied either to the mask or to a side of the surface facing the mask. The method then includes rolling the roller and the surface over the mask and flowing the paste into the openings in the mask without substantially sliding the roller and surface over the mask. In the preferred embodiment, paste is applied to a side of the surface facing the mask and the surface containing the paste is rolled over the mask. The surface may be attached to the roller. More preferably, the surface is on a film strip, separate from the roller, disposed between the roller and the substrate.

### BACKGROUND OF INVENTION

1. Field of the Invention

This invention relates to the manufacture of electronic circuit boards and, in particular, to a method and apparatus for rolling contact screening of conductive pastes through stencil masks to create lines and vias in circuit board substrates.

2. Description of Related Art

Printed circuit boards utilized in high-density electronic applications have utilized organic, i.e., epoxy and fiberglass, or ceramic, i.e., sintered green sheets, substrates which contain conductive lines, vias and other structures. Lines are deposited on the surface of the substrate, and vias are created in holes which are aligned through two or more layers of the substrate. The conductive lines are manufactured by screening a conductive paste onto the surface of the substrate and then curing the paste; the conductive vias are manufactured by filling the via openings with a conductive paste and then curing the paste. Prior art methods of applying the conductive paste into the openings in the circuit board substrate have included silk screening and pressurized nozzle application. In the former, different masks having openings aligned with either vias or lines are utilized, and conductive paste is applied by using a squeegee to force the paste through the mask line and via openings and into the substrate via openings. Such silk screening methods have had difficulty in filling vias, and the generally lower line heights result in higher electrical resistance. In the nozzle application methods, exemplified by U.S. Pat. Nos. 5,925,414 and 5,955,119 assigned to the assignee of the instant invention, nozzles are used to directly extrude the conductive paste though the stencil mask. While these nozzle application methods have been successful, there is a certain amount of strain and wear on the stencil mask as a result of the contact pressures required.

### SUMMARY OF INVENTION

Bearing in mind the problems and deficiencies of the prior art, it is therefore an object of the present invention to provide a method and apparatus for applying conductive paste to an electronic printed circuit board substrate which fills both lines and via openings in the substrate.

It is another object of the present invention to provide a method and apparatus for applying conductive paste, which results in increased life of the stencil mask used over the substrate.

It is a further object of the present invention to provide a method and apparatus that reduces the frictional force applied to the mask or stencil during screening.

It is yet another object of the present invention to provide a method and apparatus for utilizing a conductive paste more effectively and efficiently in the manufacture of electronic printed circuit boards.

The above and other objects, which will be apparent to those skilled in the art, are achieved in the present invention which provides a method of applying paste to an electronic circuit board substrate comprising providing an electronic circuit board substrate, providing over the substrate a mask having openings therein, and providing a roller having an axis and a surface adjacent the roller. Paste is then applied either to the mask or to a side of the surface facing the mask. The method then includes rolling the roller and the surface over the mask and flowing the paste into the openings in the mask without substantially sliding the roller and surface over the mask.

In the preferred embodiment, paste is applied to a side of the surface facing the mask and the surface containing the paste is rolled over the mask. The surface may be attached to the roller. More preferably, the surface is on a film strip, separate from the roller, disposed between the roller and the substrate. The paste may be applied in a bead across the surface, parallel to the roller axis, such as in a continuous or discontinuous bead across the surface, parallel to the roller axis, and at a fixed or variable rate of speed.

The paste may also be applied in a film on the surface, or may be applied selectively to the surface, conforming to areas of the mask openings. Preferably, the surface does not substantially absorb components of the paste.

The method is particularly useful where the substrate, such as organic, ceramic and metal printed circuit board substrates, contains openings for vias, and where the overlying mask contains openings for lines and openings corresponding to the substrate via openings. In such case, the paste is flowed into the mask, onto portions of the substrate below the mask line openings and into substrate via openings during the rolling of the roller and the sur- face containing the paste.

In another aspect, the present invention provides a method of applying a conductive paste to an electronic circuit board substrate comprising providing an electronic circuit board substrate, providing over the substrate a mask having openings therein, providing a roller having an axis, and providing a film between the roller and the mask. The method then includes applying conductive paste to a side of the film facing the mask and rolling the roller over the substrate while applying pressure to the film containing the conductive paste and flowing the paste into the openings in the mask and onto the substrate without substantially sliding the roller and film over the mask.

The film may be in the form of a strip, and the method may include providing a spool for the film strip, and feeding the film strip between the roller and the mask after paste is applied thereto.

A further aspect of the present invention provides an apparatus for applying paste to an electronic circuit board substrate comprising, a mask for an electronic circuit board substrate, the mask having discrete openings therein for forming structures on the substrate, a roller having an axis and a surface adjacent the roller and the mask, and a paste applicator for applying paste to a side of the surface facing the mask. The roller and the surface containing the paste are adapted to roll over the mask and flow the paste into the openings in the mask and on to the substrate without substantially sliding the roller and surface over the mask.

Preferably, the surface is on a film strip and the apparatus further includes at least one spool for feeding the film strip between the roller and the mask after paste is applied thereto. The surface is preferably made of a plastic that does not substantially absorb components of the paste, while having sufficient friction to substantially prevent slippage of the roller during rolling over the mask and flowing of the paste into the mask openings.

Yet another aspect of the present invention provides a article comprising a flexible film strip having at least a portion uniformly covered on one surface thereof with a paste for application to an electronic circuit board substrate.

In a further aspect, the present invention provides a method of applying paste to an electronic circuit board substrate comprising providing an electronic circuit board substrate, providing over the substrate a mask having openings therein for forming structures on or in the substrate, and providing a roller. There is also provided a film strip having on a surface thereof a layer of paste to be applied to the substrate. The method then includes passing the film strip between the roller and the mask, with the film strip surface containing the paste facing the mask, and applying force to the roller against the film strip and mask, while moving the roller along the mask without substantially sliding the roller and film strip surface over the mask, to flow the paste into the openings in the mask and on to the substrate.

In another aspect, the present invention provides an apparatus for applying paste to openings in an electronic circuit board substrate comprising a mask for an electronic circuit board substrate, the mask having discrete openings therein for forming structures on the substrate, and a film strip having on a surface thereof, facing the mask, a layer of paste to be applied to the mask and sub- strate. The apparatus further includes a roller, adjacent the mask, adapted to roll against the film strip and mask, without substantially sliding the roller and film surface over the mask, and flow the paste into the openings in the mask and on to the substrate.

### BRIEF DESCRIPTION OF DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by refer- ence to the detailed description which follows taken in conjunction with the accompanying drawings in which:

FIG. 1 is a side elevational view, in cross section, of a portion of the preferred rolling contact screening method and apparatus of the present invention, showing a close-up of the rolling contact forcing the paste into the mask and substrate openings.

FIG. 2 is a side elevational view, in cross section, showing a portion of the roller of FIG. 1 in an alternate embodiment.

FIG. 3 is a top plan view of a typical laminated printed circuit board overlaid with a stencil mask showing openings for the conductive lines and vias, and conductive paste filling the openings.

FIG. 4 is a side elevational view, in cross section of a portion of the stencil mask and printed circuit board of FIG. 3 along lines 4-4.

FIG. 5 is a side elevational view, in cross section, of a portion of the printed circuit board of FIG. 3 along lines 4-4, after the stencil mask has been removed.

FIG. 6 is a side elevational view of one preferred embodiment of the film feeding and conductive paste application apparatus of the present invention.

FIG. 7 is an underside view of the film of FIG. 6, showing the nozzle application of the conductive paste relative to the roller.

FIG. 8 is a side elevational view of another preferred embodiment of the conductive paste applicator of the present invention.

FIG. 9 is an end elevational view showing the conductive paste nozzle with respect to the film and roller.

### DETAILED DESCRIPTION

In describing the preferred embodiment of the present invention, reference will be made herein to FIGS. 1-9 of the drawings in which like numerals refer to like features of the invention.

The preferred apparatus and method of the present invention simultaneously screens lines and fills vias while maintaining purely rolling contact with the screening or stencil mask utilized over the printed circuit board substrate. The basic features of the method and apparatus are depicted in FIG. 1 in which a workpiece fixture 70 has mounted thereon a single layer of a printed circuit board substrate 60 and, directly thereover, stencil mask 50. Substrate 60 has discrete, spaced-apart openings 62, 62′ therein and mask 50 has corresponding openings 52, 52′ respectively aligned with the substrate openings. The purpose of the stencil mask openings is to permit conductive paste to be forced into the stencil mask openings only, and to form the desired conductive lines on the substrate surface and fill the substrate openings to form conductive vias, without applying the paste to the remaining surface of the substrate.

A roller 20 having a cylindrical surface and a central axis of rotation 24 is positioned over substrate 60 and stencil mask 50. Between mask 50 and the roller, there is provided a continuous strip of flexible film having a lower surface 32 upon which a conductive paste 40 is applied. As the roller moves horizontally in the x-direction 28, pressure is applied in the z-direction 27 downward against the film strip 30 and conductive paste 40 to force the conductive paste to flow first into stencil openings 52 and onto the top surface of substrate 60 and into any substrate via opening 62. The friction between the outer surface 22 of roller 20 and the upper surface 34 of film strip 30 causes roller 22 rotate clockwise in direction 26 as shown. While the roller 20 may be powered to cause rotation, for example, by a gear drive (not shown), in the preferred embodiment the roller is freewheeling using ball bearing races (not shown), so that movement in the x-direction causes the angular rotation of the roller. The width of the roller 20 and film strip 30 generally correspond approximately to the width of the mask and substrate being processed.

The preferred film 30 is made of Mylar, a polyester film. Other organic or non-organic, i.e., metal, films may be utilized provided that they do not absorb or permit the paste to pass therethrough and onto the roller surface, and have sufficient friction, in conjunction with the roller surface, to enable the roller to maintain rolling contact without substantial sliding as the roller and film pass over the stencil mask. Although the film is flexible, i.e., it may be wrapped around roller 20, it preferably does not stretch in its longitudinal direction to any significant degree under forces encountered in handling and deploying the film. More preferably, the film is clear so as to enable observation of the paste, stencil mask and other components of the apparatus during the application process.

Although the embodiment is illustrated by reference to use of a conductive paste, any paste-like substance may be utilized. Such pastes may be any flowable material utilized in the manufacture of ceramic boards, for example ceramic pastes, metallic pastes, high resistance dielectric pastes, solder dams (epoxy) pastes, carbon resistor pastes, tin-lead solder pastes, lead-free solder pastes and elastomeric conductive paste i.e. for Z interconnects. These pastes may be made with an organic filler material filled with conductive or non-conductive materials, as the application requires. The organic material may be a thermoset or thermoplastic resin. Such pastes are well known in the art of manufacturing printed circuit boards.

The substrate to which the paste is applied may be a ceramic substrate, such as an alumina ceramic greensheet, or an organic substrate e.g., epoxy, filled with fiberglass or other polyaramide fibers, or a flexible substrate of dielectric polymer films, e.g., polyimide, and metal foils, e.g., copper. The stencil masks may be any of those used in a prior art such as photoetched or electroformed metal, e.g., stainless steel, or other materials such as silkscreen painting masks or stainless steel photo polymer masks.

The pressure roller 20 may be made of a metal such as steel or more flexible, e.g., polymeric, materials to reduce sensitivity to contamination debris and mask irregularities. The force in direction 27 applied by the roller to paste 40 creates a bow wave of paste 42. The paste pressure is dependent on the roller diameter, speed of the stroke in direction 28, the force in direction 27, the rheological properties of the paste (e.g., viscosity and the like), the amount of paste applied, and the volume of paste in bow wave 42. The paste may be applied in discrete amounts such as shown by paste bead 40′, to correspond to those areas having openings, e.g., stencil mask openings 52′ and substrate openings 62′. The speed of forward (28) movement of the roller nozzle may be varied during the screening stroke to compensate for variations in bow wave volume and/or shear thinning of the paste. Typical roller nozzle 20 speed in such forward movement is from about 0.4 to 10 cm/sec.

Although the preferred embodiment of the present invention utilizes a surface on which the paste is applied which is in the form of a film strip, separate from the roller, in an alternate embodiment, surface 32 (on which the paste is applied) may be attached to the roller itself, as shown in FIG. 2. In such case, surface 32 may be adhered or bonded to, or otherwise formed on, the surface of roller 20, and the paste may be applied directly thereto. Alternatively, the paste bead 40′ may be applied to the top surface of the mask, rather than on film 30, ahead of roller 20 at the start of the stroke position.

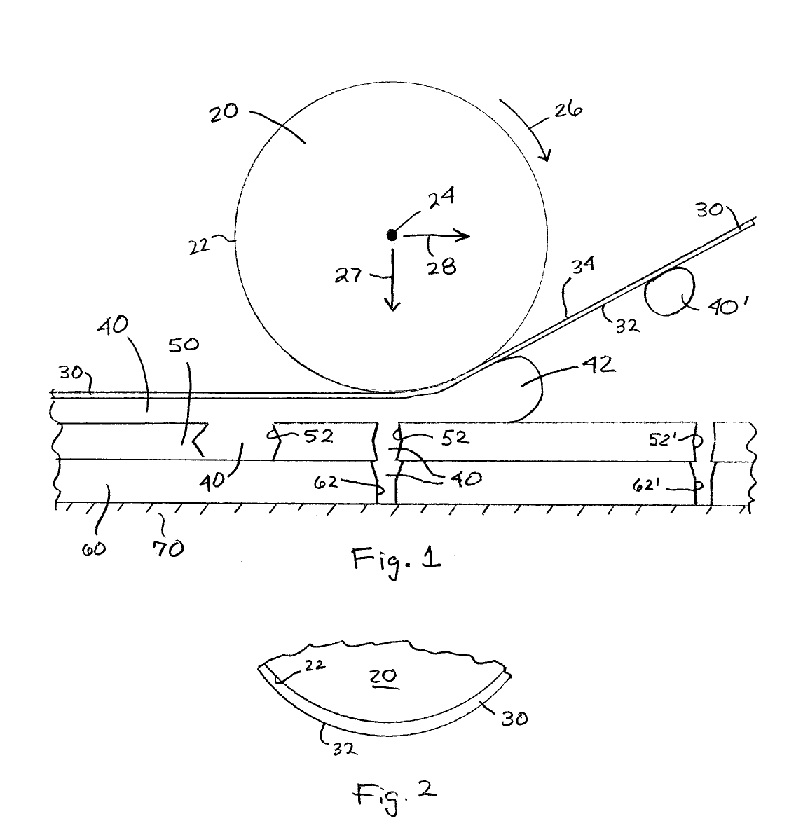

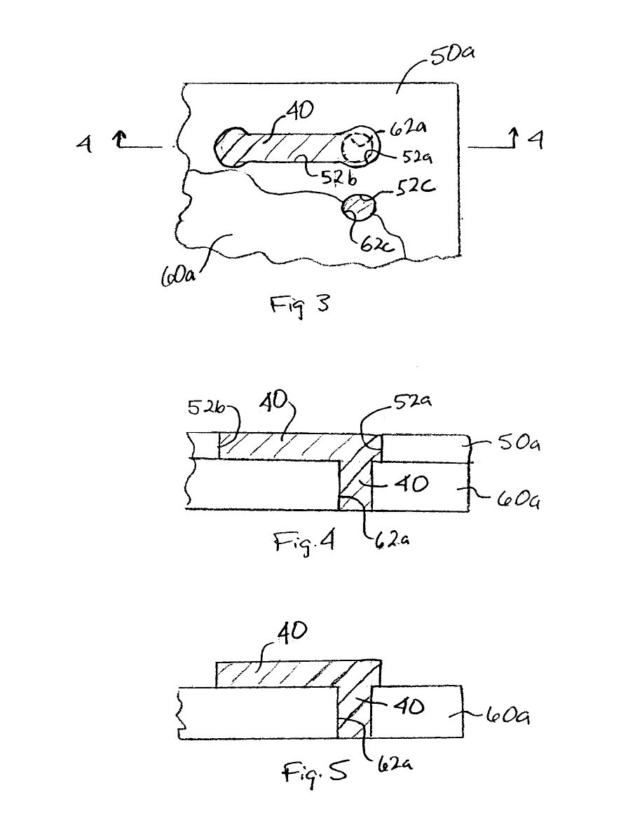

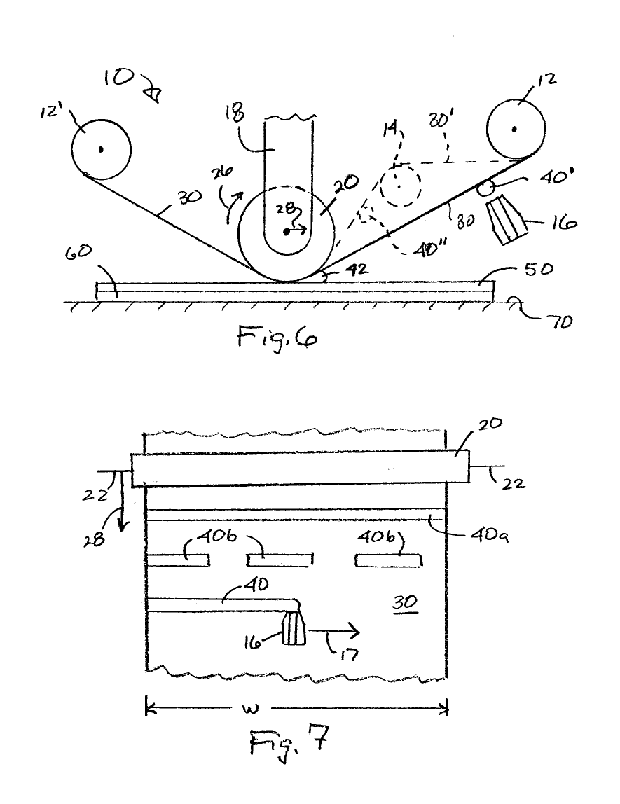

The use of a stencil mask to apply conductive paste to a typical circuit board substrate to form conductive lines and vias is shown in FIGS. 3 and 4. A single layer 60a of a circuit board substrate includes via openings 62a, 62c in which conductive paste is to be deposited. An overlying stencil mask 50a has via opening 52a, 52c, corresponding to underlying substrate openings 62a, 62c, respectively, and extended line opening 52b. One end of line opening 52b meets with via opening 52a. The ends of the line openings in mask 50a are enlarged, compared to the via openings in substrate 60a. All of these via and line openings in stencil mask 50a, and via openings in substrate 60a, are filled with conductive paste 40, as the substrate layer is processed in accordance with the present invention. As shown in FIG. 5, after the stencil mask is removed, there remain the conductive lines on the surface of the substrate, and vias on the substrate surface and extending into the substrate openings, formed by conductive paste 40. No paste remains on the surface of substrate 40 outside of the mask openings.

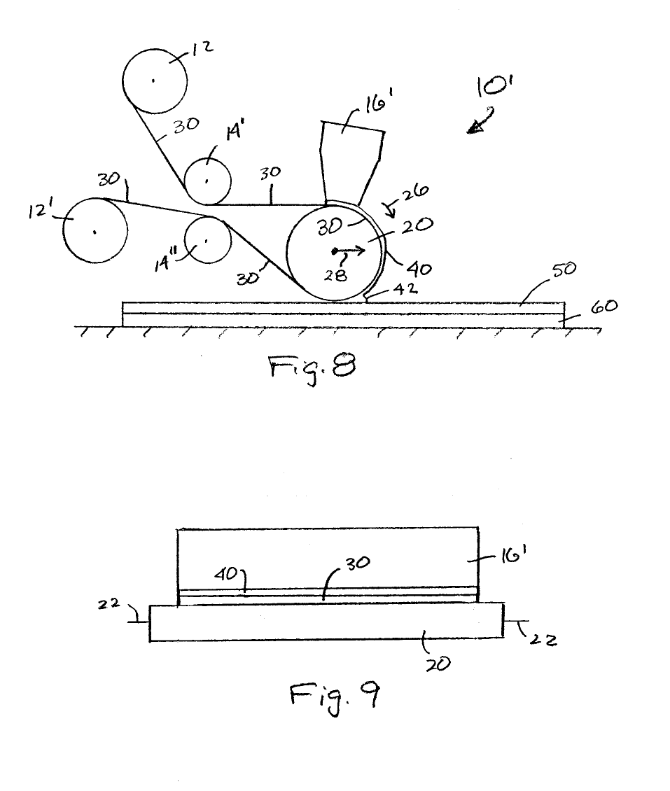

A first film-handling embodiment of the present invention is depicted in FIGS. 6 and 7, wherein apparatus 10 includes film supply spool 12 and film take-up spool 12′. Spool 12 feeds a strip of film 30 on which a bead 40′ of conductive paste is applied to the lower film surface by a nozzle 16. Nozzle 16 is connected to a source of the conductive paste (not shown). In an alternate embodiment, shown in phantom lines, an idler roller 14 changes the direction of film 30′ so that conductive bead 40″, is applied to the film at a higher angle with respect to the surface of stencil mask 50. Roller 20 is itself mounted for rolling movement on apparatus frame 18, to move in the x-direction as shown by arrow 28 while maintaining angular, non-sliding rotation as shown by arrow 26. After film 30 passes beneath roller 20, between the roller and the stencil mask, it is taken up by spool 12′. In FIG. 7, there are depicted the various methods of applying the conductive paste in a bead across width w of film 30. Preferably, nozzle 16 is movable and applies conductive paste 40 in a bead as it travels in y-direction 17, across the width of the film. This bead may be either a continuous bead, 40a, or discontinuous bead in discrete sections, 40b. Because of effects of applying the bead of conductive paste near the edges of film strips 30, at the beginning and end of the traverse of nozzle head 16, nozzle 16 may operate at a variable rate of speed for example, slightly faster at the beginning and end of the traverse to apply a lesser amount of paste near the edges of film 30. Typical nozzle 16 velocities are from about 0.25 to 7.5 cm/sec. Nozzle 16 may be heated to handle higher viscosity pastes.

The pressure roller 20 may also be heated to reduce paste viscosity and improve screening quality. The use of a rolling contact method as an apparatus as depicted herein creates sufficient pressure wedge on the paste to fill lines and vias simultaneously, while still reducing local pressure on the mask due to the increased contact area. This reduces strain on the mask and substrate in the direction of travel 28 of the roller.

Another embodiment of the apparatus 10′ of the present invention is depicted in FIG. 8, wherein paste 40 is applied as a uniform film across the entire surface, or portions of the surface, of film 30. Film 30 is supplied from payoff spool 12 and passes under roller 14′ to contact pressure roller 20. A nozzle 16′, extending across nearly the entire width of film 30, applies paste 40 in a thin uniform film.

Paste 40 then passes beneath roller 20 and is applied by film 30 to the top of stencil mask 50, in the manner previously described. Film 30 then passes over idler roller 14″ and onto take-up spool 12′.

In addition to the in-line nozzle shown in the drawings applying the paste in the vicinity of the roller, the paste may be pre-applied, either in beads or as a uniform film, to the surface of film 30.

By way of example only, the pressure roller herein may have a diameter ranging from about 15 to 25 mm in diameter, and a width of approximately 200 mm. The Mylar film has a thickness of approximately 0.05 to 0.1 mm.

Thus the present invention achieves the objects stated above. It provides for the application of a variety of different pastes to printed circuit boards, while increasing the life of screening or stencil masks, and the accuracy of screening because of a reduction of friction in the direction of travel. This also reduces the stress and strain on the substrate along the direction of screening.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A method of applying paste to an electronic circuit board substrate comprising:
providing an electronic circuit board substrate;
providing over the substrate a mask having openings therein;
providing a roller having an axis and a surface adjacent the roller;
applying paste to the mask or a side of the surface facing the mask; and
rolling the roller and the surface over the mask and flowing the paste into the openings in the mask without substantially sliding the roller and surface over the mask.

2. A method of applying paste to an electronic circuit board substrate comprising:
providing an electronic circuit board substrate;
providing over the substrate a mask having openings therein;
providing a roller having an axis and a surface adjacent the roller;
applying paste to a side of the surface facing the mask; and
rolling the roller and the surface containing the paste over the mask and flowing the paste into the openings in the mask without substantially sliding the roller and surface over the mask.

3. The method of claim 2 wherein the surface is on a film strip, separate from the roller, disposed between the roller and the substrate.

4. The method of claim 2 wherein the paste is applied in a bead across the surface, parallel to the roller axis.

5. The method of claim 2 wherein the paste is applied in a continuous bead across the surface, parallel to the roller axis.

6. The method of claim 2 wherein the paste is applied in a discontinuous bead across the surface, parallel to the roller axis.

7. The method of claim 2 wherein the paste is applied in a bead across the surface, parallel to the roller axis, at a variable rate of speed.

8. The method of claim 2 wherein the paste is applied in a film on the surface.

9. The method of claim 2 wherein the paste is applied selectively to the surface, conforming to areas of the mask openings.

10. The method of claim 2 wherein the surface is attached to the roller.

11. The method of claim 2 wherein the surface does not substantially absorb components of the paste.

12. The method of claim 2 wherein the substrate contains openings for vias, and wherein the overlying mask contains openings for lines and openings corresponding to the substrate via openings, and wherein the paste is flowed into the mask, onto portions of the substrate below the mask line openings and into substrate via openings during the rolling of the roller and the surface containing the paste.

13. The method of claim 2 wherein the substrate is selected from the group consisting of organic, ceramic and metal printed circuit board substrates.

14. The method of claim 2 wherein velocity of the roller is varied to compensate for variations in bow wave volume or shear thinning of the paste.

15. A method of applying a conductive paste to an electronic circuit board substrate comprising:
providing an electronic circuit board substrate;
providing over the substrate a mask having openings therein;
providing a roller having an axis;
providing a film between the roller and the mask;
applying conductive paste to a side of the film facing the mask; and
rolling the roller over the substrate while applying pressure to the film containing the conductive paste and flowing the paste into the openings in the mask and onto the substrate without substantially sliding the roller and film over the mask.

16. The method of claim 15 wherein the paste is applied in a continuous bead across the film, parallel to the roller axis.

17. The method of claim 15 wherein the paste is applied in a discontinuous bead across the film, parallel to the roller axis.

18. The method of claim 15 wherein the paste is applied in a bead across the surface, parallel to the roller axis, at a variable rate of speed.

19. The method of claim 15 wherein the film is in the form of a strip, and including providing a spool for the film strip, and feeding the film strip between the roller and the mask after paste is applied thereto.

20. An apparatus for applying paste to an electronic circuit board substrate comprising:
a mask for an electronic circuit board substrate, the mask having discrete openings therein for forming structures on the substrate;
a roller having an axis and a surface adjacent the roller and the mask;
a paste applicator for applying paste to a side of the surface facing the mask;
the roller and the surface containing the paste being adapted to roll over the mask and flow the paste into the openings in the mask and on to the substrate without substantially sliding the roller and surface over the mask.

21. The apparatus of claim 20 wherein the surface is on a film strip and further including at least one spool for feeding the film strip between the roller and the mask after paste is applied thereto.

22. The apparatus of claim 21 wherein the surface is made of a plastic that does not substantially absorb compo- nents of the paste, while having sufficient friction to substantially prevent slippage of the roller during rolling over the mask and flowing of the paste into the mask openings.

23. An article comprising a flexible film strip having at least a portion uniformly covered on one surface thereof with a paste for application to a an electronic circuit board substrate.

24. A method of applying paste to an electronic circuit board substrate comprising:
providing an electronic circuit board substrate;
providing over the substrate a mask having openings therein for forming structures on or in the substrate;
providing a roller;
providing a film strip having on a surface thereof a layer of paste to be applied to the substrate;
passing the film strip between the roller and the mask, with the film strip surface containing the paste facing the mask; and
applying force to the roller against the film strip and mask, while moving the roller along the mask without substantially sliding the roller and film strip surface over the mask, to flow the paste into the openings in the mask and on to the substrate.

25. An apparatus for applying paste to openings in an electronic circuit board substrate comprising:
a mask for an electronic circuit board substrate, the mask having discrete openings therein for forming structures on the substrate;
a film strip having on a surface thereof, facing the mask,
a layer of paste to be applied to the mask and substrate; and
a roller, adjacent the mask, adapted to roll against the film strip and mask, without substantially sliding the roller and film surface over the mask, and flow the paste into the openings in the mask and on to the substrate.
